(19) United States
(12) Patent Application Publication
(10) Pub. No.: US 2016/0154642 A1
(43) Pub. Date: Jun. 2, 2016

(54) Aircraft Software Configuration Selection and Installation

(71) Applicant: The Boeing Company, (US)

(72) Inventors: Cory C. Mason, Burien, WA (US); Susan L. Novak, Seal Beach, CA (US); Matthew B. Bull, Seattle, WA (US); William Geroge Vlases, Des Moines, WA (US)

(73) Assignee: THE BOEING COMPANY, Chicago, IL (US)

(21) Appl. No.: 13/755,804

(22) Filed: Jan. 31, 2013

Related U.S. Application Data
(60) Provisional application No. 61/683,112, filed on Aug. 14, 2012.

(51) Int. Cl. G06F 9/445; H04L 29/08

(52) U.S. Cl. CPC G06F 8/65; H04L 67/12

(57) ABSTRACT

A system and method for selecting and installing a software configuration for an aircraft. A configuration tool is configured to display configuration options for aircraft software to a user and to receive configuration selections for the aircraft software from the user. The configuration selections identify selected ones of the configuration options. The configuration tool is further configured to send the configuration selections to a software installer for installation on the aircraft of the aircraft software identified by the configuration selections.

This application claims the benefit of U.S. Provisional Application No. 61/683,112, filed Aug. 14, 2012, the disclosure of which is incorporated herein in its entirety.

### BACKGROUND INFORMATION

1. Field

The present disclosure relates generally to software parts for aircraft. Still more particularly, the present disclosure relates to the selection of software aircraft part configurations and the installation of selected software aircraft parts on an aircraft.

2. Background

Modern aircraft are extremely complex. For example, an aircraft may have many types of electronic systems on-board. These systems are often in the form of line-replaceable units (LRUs). A line-replaceable unit is an item that may be removed and replaced from an aircraft. A line-replaceable unit is designed to be easily replaceable.

A line-replaceable unit may take on various forms. A line-replaceable unit on an aircraft may be, for example, without limitation, a flight management system, an autopilot, an in-flight entertainment system, a communications system, a navigation system, a flight controller, a flight recorder, a collision avoidance system, a system to support maintenance functions, or a system to support crew processes. The various line-replaceable units on an aircraft may be parts of an aircraft network data processing system.

Line-replaceable units may use software or programming to provide the logic or control for various operations and functions. Software on an aircraft may be treated as separate parts of the aircraft or may be combined with hardware parts of the aircraft. Aircraft software that is treated as a separate aircraft part may be referred to as a loadable software aircraft part or a software aircraft part. Software aircraft parts are parts of the configuration of an aircraft.

Aircraft operators are entities that operate aircraft. Aircraft operators also may be responsible for the maintenance and repair of aircraft. Examples of aircraft operators include airlines and military units. Software aircraft parts may already be installed in the line-replaceable units on an aircraft when the aircraft is delivered by an aircraft manufacturer to the aircraft operator.

An airline or other aircraft operator may desire to customize the configuration of aircraft that are produced by an aircraft manufacturer for the operator. For example, without limitation, the aircraft operator may provide software to the aircraft manufacturer for installation on the aircraft during the manufacturing process. Such software may be configured in various different ways. Such software may be developed by the aircraft operator or by a third party software developer. The aircraft manufacturer also may offer options to the aircraft operator for various different configurations of software that may be installed on the aircraft.

In order to provide an aircraft with a customized configuration to an aircraft operator, it may desirable that the aircraft operator selects the desired configuration of software aircraft parts to be installed on the aircraft and communicates those selections to the aircraft manufacturer. The aircraft manufacturer then may identify the selections made by the aircraft operator and install the selected software aircraft parts on the aircraft before delivering the aircraft to the aircraft operator. It is desirable that the selection of software aircraft part configurations is made and communicated accurately and in an efficient manner from the aircraft operator to the aircraft manufacturer so that the aircraft manufacturer may install the correct software aircraft parts on the aircraft in an efficient manner during the aircraft manufacturing process.

Accordingly, it would be beneficial to have a method and apparatus that takes into account one or more of the issues discussed above, as well as possibly other issues.

### SUMMARY

An illustrative embodiment of the present disclosure provides an apparatus comprising a configuration tool. The configuration tool is configured to display configuration options for aircraft software to a user and to receive configuration selections for the aircraft software from the user. The configuration selections identify selected ones of the configuration options. The configuration tool is further configured to send the configuration selections to a software installer for installation on an aircraft of the aircraft software identified by the configuration selections.

Another illustrative embodiment of the present disclosure provides a method for selecting a configuration for an aircraft. A configuration tool is accessed. Aircraft software to configure is selected from a list of aircraft software displayed by the configuration tool. A configuration for the aircraft software to configure is selected from a list of configurations for the aircraft software to configure displayed by the configuration tool.

Another illustrative embodiment of the present disclosure provides a method for installing software on an aircraft. A configuration tool is accessed by a data processing system. Installation instructions from the configuration tool for installing aircraft software on the aircraft are displayed by the data processing system. The installation instructions identify selected aircraft software selected from configuration options for the aircraft software displayed by the configuration tool.

The features, functions, and benefits can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives, and benefits thereof, will best be understood by reference to the following detailed description of illustrative embodiments of the present disclosure when read in conjunction with the accompanying drawings, wherein:

FIG. 1 is an illustration of a block diagram of an aircraft manufacturing and service environment in accordance with an illustrative embodiment;

FIG. 2 is an illustration of a block diagram of a configuration tool in accordance with an illustrative embodiment;

FIG. 3 is an illustration of information transfer for using a configuration tool in accordance with an illustrative embodiment;

FIG. 4 is an illustration of a user interface for selecting an application group of software aircraft parts to be configured in accordance with an illustrative embodiment;

FIG. 5 is an illustration of a user interface for selecting a software aircraft part to be configured in accordance with an illustrative embodiment;

FIG. 6 is an illustration of a user interface for selecting a configuration for a software aircraft part in accordance with an illustrative embodiment;

FIG. 7 is an illustration of a user interface for authorizing installation of an application group of configured software aircraft parts in accordance with an illustrative embodiment;

FIG. 8 is an illustration of a user interface for authorizing an aircraft configuration in accordance with an illustrative embodiment;

FIG. 9 is an illustration of a flowchart of a process for using a configuration tool to configure software aircraft parts in accordance with an illustrative embodiment;

FIG. 10 is an illustration of a flowchart of a process for using a configuration tool to install software aircraft parts on an aircraft in accordance with an illustrative embodiment;

FIG. 11 is an illustration of a block diagram of an aerospace vehicle manufacturing and service method in accordance with an illustrative embodiment;

FIG. 12 is an illustration of a block diagram of an aerospace vehicle in which an illustrative embodiment may be implemented; and

FIG. 13 is an illustration of a data processing system in accordance with an illustrative embodiment.

### DETAILED DESCRIPTION

The different illustrative embodiments recognize and take into account a number of different considerations. “A number,” as used herein with reference to items, means one or more items. For example, “a number of different considerations” means one or more different considerations.

The different illustrative embodiments recognize and take into account that new aircraft designs may allow airlines and other aircraft operators to customize their aircraft in many different ways. Aircraft manufacturers may allow aircraft operators to select from an increasing number of software aircraft part configurations to be installed on an aircraft before the aircraft is delivered to the aircraft operator. In this case, it is desirable that the aircraft operator is able to select from among various software aircraft part configurations that may be available and communicate the selections to the aircraft manufacturer in an accurate and efficient manner. Similarly, it is desirable that the aircraft manufacturer may receive the software aircraft part configuration selections from the aircraft operator and install the selected software aircraft parts on the aircraft in an efficient manner.

One or more of the illustrative embodiments provides a system and method for selecting and installing a software configuration for an aircraft in an accurate and efficient manner. One or more of the illustrative embodiments provides a configuration tool that may be accessed by an aircraft operator or other user to select and manage the installation of software aircraft parts on an aircraft. The configuration tool may be accessed by the aircraft operator or other user via a computer network, such as the Internet. The configuration tool may provide user friendly interfaces for guiding the user to select a desired configuration for software to be installed on the aircraft.

Options for aircraft software configurations may be loaded into the configuration tool by the aircraft manufacturer or another authorized entity. These configuration options may be displayed to the aircraft operator or other user by the configuration tool. The aircraft operator or other user may use the configuration tool to select a configuration of the aircraft software from the displayed configuration options. The aircraft operator or other user also may use the configuration tool to authorize installation of the selected aircraft software configuration on the aircraft.

The configuration tool also may be configured to assist an aircraft manufacturer or other software installer to install an aircraft software configuration selected by an aircraft operator on an aircraft in an efficient manner. For example, the configuration tool may notify the software installer when the aircraft operator or other user authorizes installation of a selected aircraft software configuration on an aircraft. The configuration tool may provide installation instructions for installing the selected aircraft software configuration to a portable installation device. The installation instructions may identify software for the selected aircraft software configuration to be installed on the aircraft. The software installer may use the installation instructions to load the software for the selected aircraft software configuration on the portable installation device. The software installer then may install the software for the selected aircraft software configuration on the aircraft from the portable installation device. The software installer may provide confirmation back to the configuration tool to indicate that the software for the selected aircraft software configuration has been installed on the aircraft.

An aircraft operator or other user may use the configuration tool to manage an aircraft configuration. For example, the configuration tool may be configured to generate an installation report. The installation report may include information identifying when a selected aircraft software configuration is installed on the aircraft. The configuration tool also may be configured to generate a configuration report. The configuration report may include information identifying the configuration of the aircraft, including the selected aircraft software configuration installed on the aircraft.

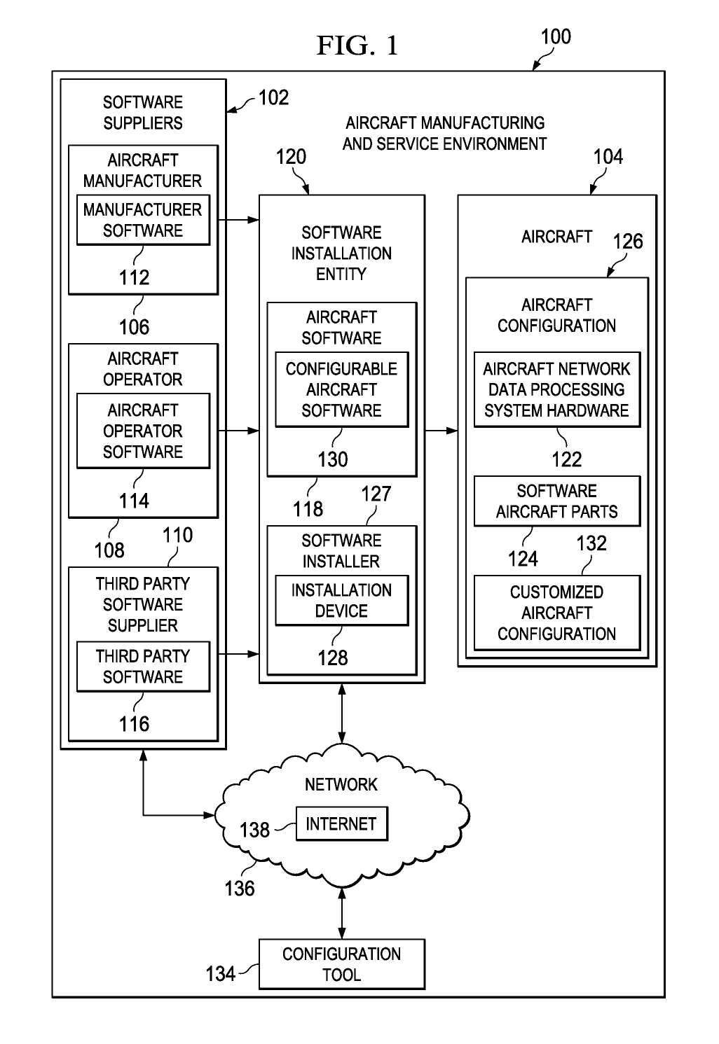

Turning now to FIG. 1, an illustration of a block diagram of an aircraft manufacturing and service environment is depicted in accordance with an illustrative embodiment. In this example, aircraft manufacturing and service environment 100 may include software suppliers 102. Software suppliers 102 may provide software applications or other software for use on aircraft 104. Software suppliers 102 may include any entity that develops or otherwise supplies software for use on aircraft 104. For example, without limitation, software suppliers 102 may include aircraft manufacturer 106, aircraft operator 108, and third party software supplier 110.

Aircraft manufacturer 106 may manufacture aircraft 104 and provide manufacturer software 112. Aircraft operator 108 may operate aircraft 104 and provide aircraft operator software 114. Aircraft operator 108 may be, for example, without limitation, an airline, military organization, or any other private or government entity that operates aircraft 104. Third party software supplier 110 may provide third party software 116. For example, without limitation, third party software supplier 110 may provide third party software 116 at the request of aircraft manufacturer 106, aircraft operator 108, or both. Manufacturer software 112, aircraft operator software 114, third party software 116, or any combination thereof, may comprise aircraft software 118 for use on aircraft 104.

Software installation entity 120 in aircraft manufacturing and service environment 100 may install aircraft software 118 on aircraft 104. Software installation entity 120 may be any entity that may install aircraft software 118 on aircraft 104. For example, software installation entity 120 may include aircraft manufacturer 106, aircraft operator 108, or any combination of these or other entities. In particular, software installation entity 120 may include aircraft manufacturer 106 or another appropriate entity when aircraft software 118 is installed on aircraft 104 by software installation entity 120 while aircraft 104 is being manufactured and before aircraft 104 is delivered from aircraft manufacturer 106 to aircraft operator 108. Software installation entity 120 may include aircraft manufacturer 106, aircraft operator 108, or another appropriate entity when aircraft software 118 is installed on aircraft 104 by software installation entity 120 after aircraft 104 is delivered to aircraft operator 108. Software installation entity 120 may or may not be the owner of aircraft 104. Software installation entity 120 may include an entity acting on behalf of the owner or operator of aircraft 104 to install aircraft software 118 on aircraft 104. In any case, it may be assumed that software installation entity 120 has authority to install aircraft software 118 on aircraft 104.

Aircraft 104 may be a commercial or private passenger aircraft, cargo aircraft, or a military or other government aircraft. Aircraft 104 may include aircraft network data processing system hardware 122. For example, aircraft software 118 may be configured to run on aircraft network data processing system hardware 122. Aircraft software 118 may be installed on aircraft 104 in the form of software aircraft parts 124. Aircraft network data processing system hardware 122 and software aircraft parts 124 installed on aircraft 104 together may define a portion of aircraft configuration 126. Software aircraft parts 124 may be installed on aircraft 104 by software installation entity 120. Software installation entity 120 may follow specified procedures for installing software aircraft parts 124 on aircraft 104 so that aircraft configuration 126, including all of software aircraft parts 124 currently installed on aircraft 104, is known.

Software installation entity 120 may employ software installer 127 for installing aircraft software 118 on aircraft 104. For example, without limitation, software installer 127 may include a technician or other personnel who may be trained to install aircraft software 118 on aircraft 104 in accordance with specified procedures.

Software installer 127 may use installation device 128 to install aircraft software 118 on aircraft 104. Installation device 128 may be a portable data processing device. For example, without limitation, installation device 128 may be a laptop computer, other portable computer, or other type of portable data processing device.

Installation device 128 may be configured to be connected to aircraft network data processing system hardware 122 on aircraft 104. Installation device 128 may be connected via a wired or wireless connection to aircraft network data processing system hardware 122 on aircraft 104. Aircraft software 118 to be installed on aircraft 104 may be loaded on installation device 128. Aircraft software 118 loaded on installation device 128 may be installed on aircraft 104 via the connection between installation device 128 and aircraft network data processing system hardware 122 on aircraft 104. Installation device 128 may be used by software installer 127 to install aircraft software 118 on aircraft 104 in the form of software aircraft parts 124.

In accordance with an illustrative embodiment, aircraft software 118 may include configurable aircraft software 130. Configurable aircraft software 130 may include any software or components or features of software that may be selected optionally for installation on aircraft 104. For example, without limitation, configurable aircraft software 130 may comprise a portion of aircraft software 118 that may be selected by aircraft operator 108 or another entity for installation on aircraft 104 to create customized aircraft configuration 132 for aircraft 104. For example, without limitation, customized aircraft configuration 132 may include any portion of aircraft configuration 126 that may be configured for aircraft operator 108 or another entity in a manner that may be different from the configuration of another aircraft of the same type as aircraft 104.

Configurable aircraft software 130 may include many options for various configurations of aircraft software 118 that may be installed on aircraft 104. In accordance with an illustrative embodiment, configuration tool 134 may be used to improve processes for selecting, installing, and tracking configurable aircraft software 130 on aircraft 104 in an accurate and efficient manner. Configuration tool 134 may be accessed by various users via network 136. For example, without limitation, network 136 may include Internet 138 or any other network or combination of networks of computers or other data processing systems.

In accordance with an illustrative embodiment, aircraft operator 108 or another entity may access configuration tool 134 via network 136. Various options for configurations of aircraft software 118 that may be installed on aircraft 104 may be displayed by configuration tool 134 to aircraft operator 108 or another entity. Aircraft operator 108 or another entity may select configurable aircraft software 130 to be installed on aircraft 104 from the various options for configurations of aircraft software 118 displayed by configuration tool 134.

In accordance with an illustrative embodiment, software installation entity 120 or another entity may access configuration tool 134 via network 136 to identify configurable aircraft software 130 to be installed on aircraft 104. For example, without limitation, software installer 127 may connect installation device 128 to configuration tool 134 via network 136 to retrieve installation instructions generated by configuration tool 134. The installation instructions may identify configurable aircraft software 130 selected by aircraft operator 108 or another entity to be installed on aircraft 104. After installing the identified configurable aircraft software 130 on aircraft 104, software installer 127 may send an indication to configuration tool 134 via installation device 128 and network 136 to confirm that the selected configurable aircraft software 130 has been installed on aircraft 104.

In accordance with an illustrative embodiment, configuration tool 134 also may be configured to generate various reports that may be used by aircraft operator 108 or other entities to manage aircraft configuration 126. Such reports may be retrieved by aircraft operator 108 or another entity from configuration tool 134 via network 136. For example, without limitation, configuration tool 134 may be configured to generate an installation report identifying configurable aircraft software 130 installed on aircraft 104. Configuration tool 134 also may be configured to generate a configuration report identifying aircraft configuration 126 including configurable aircraft software 130 installed on aircraft 104.

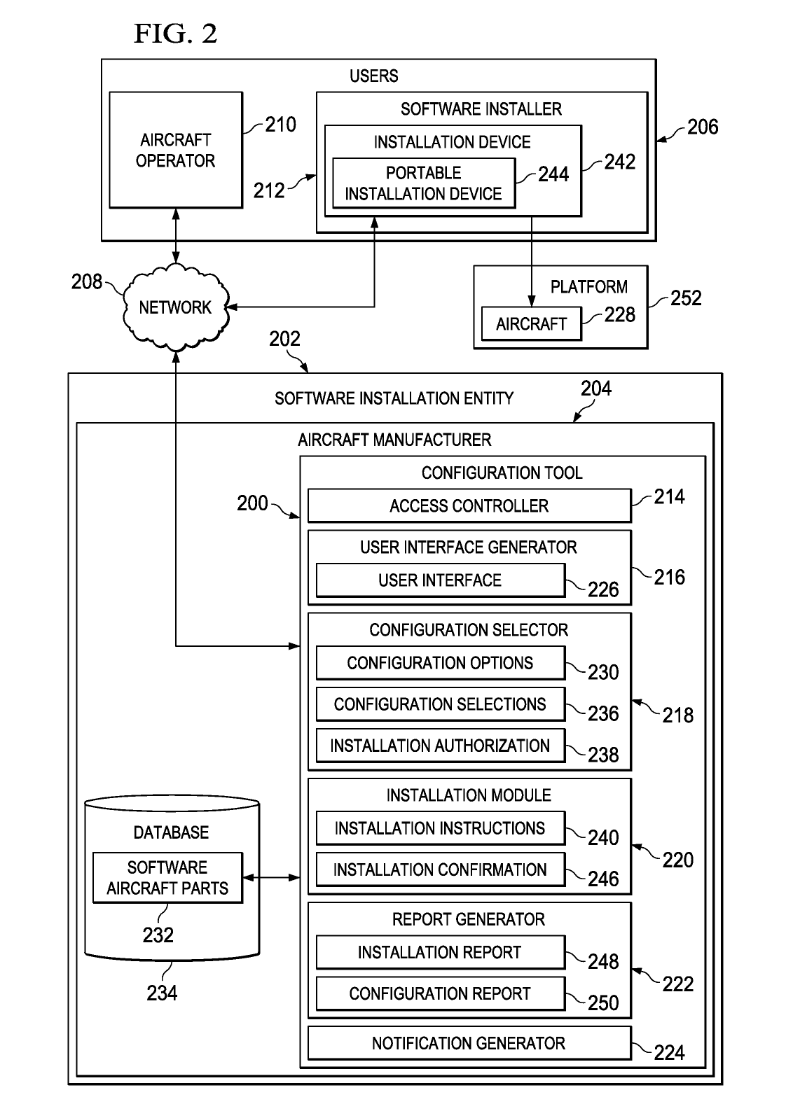

Turning now to FIG. 2, an illustration of a block diagram of a configuration tool is depicted in accordance with an illustrative embodiment. In this example, configuration tool 200 is an example of one implementation of configuration tool 134 in FIG. 1.

Configuration tool 200 may be implemented and operated by software installation entity 202. For example, configuration tool 200 may be implemented and operated on a data processing system that may be owned or otherwise controlled by software installation entity 202. For example, without limitation, configuration tool 200 may be implemented and operated, in whole or in part, on data processing resources that may be provided as a service to software installation entity 202 by a provider of data processing resources. For example, without limitation, software installation entity 202 may be aircraft manufacturer 204 or another entity. In this example, software installation entity 202 may be an example of software installation entity 120 in FIG. 1 and aircraft manufacturer 204 may be an example of aircraft manufacturer 106 in FIG. 1.

Configuration tool 200 may be configured to allow users 206 to access configuration tool 200 via network 208. For example, without limitation, network 208 may include the Internet or another network of data processing systems or a combination of various networks of data processing systems. In this example, network 208 may be an example of one implementation of network 136 in FIG. 1. For example, configuration tool 200 may be configured to allow users 206 to access configuration tool 200 via network 208 using a secure interface.

For example, without limitation, users 206 of configuration tool 200 may include aircraft operator 210, software installer 212, or other entities or various combinations of entities. Users 206 may include human beings that are employed by or otherwise associated with aircraft operator 210, software installer 212, or other entities or various combinations of entities. In this example, aircraft operator 210 may be an example of aircraft operator 108 in FIG. 1 and software installer 212 may be an example of software installer 127 in FIG. 1.

Configuration tool 200 may comprise access controller 214, user interface generator 216, configuration selector 218, installation module 220, report generator 222, and notification generator 224. Access controller 214 may be configured to control access to and use of configuration tool 200 by users 206. For example, without limitation, access controller 214 may be configured to require users 206 to present passwords or other identifying information or various combinations of information for identifying users 206 to configuration tool 200. Access controller 214 may be configured to use the identifying information provided by users 206 to determine whether users 206 are allowed to access and use configuration tool 200. Access controller 214 also may be configured to require users 206 to provide information identifying particular aircraft. Access controller 214 may be configured to use the identifying information provided by users 206 to identify particular aircraft that may be configured by users 206 using configuration tool 200.

User interface generator 216 may be configured to generate user interfaces 226. User interfaces 226 may include graphical user interfaces that may be displayed to users 206 by configuration tool 200 to provide for user friendly interactions between users 206 and configuration tool 200. For example, user interface generator 216 may be configured to generate user interfaces 226 for user interactions with access controller 214, configuration selector 218, or other components or various combinations of components of configuration tool 200. For example, without limitation, user interfaces 226 may be configured to display various options for software configurations for aircraft 228 to users 206 in a manner so as to prompt users 206 to select configurations of software to be installed on aircraft 228. User interfaces 226 also may be configured to receive input from users 206 for identifying selected configurations of software to be installed on aircraft 228.

Configuration selector 218 may be configured to display configuration options 230 to aircraft operator 210 or other users 206. For example, configuration selector 218 may be configured to display options for various configurations of software aircraft parts 232 that may be installed on aircraft 228. Software aircraft parts 232 may be provided by a variety of software suppliers. For example, without limitation, software aircraft parts 232 may include configurable software aircraft parts. In this example, software aircraft parts 232 may be an example of one implementation of aircraft software 118 in FIG. 1. Software aircraft parts 232 may be stored in database 234. Database 234 may be implemented in a number of storage devices that may be accessible by configuration tool 200.

Configuration selector 218 also may be configured to receive configuration selections 236 from aircraft operator 210 or other users 206. Configuration selections 236 may identify selected ones of configuration options 230 selected by aircraft operator 210 or other users 206 for installation on aircraft 228.

Configuration selector 218 also may be configured to receive installation authorization 238 from aircraft operator 210 or other users 206. For example, installation authorization 238 may indicate approval by aircraft operator 210 or other users 206 to install selected software aircraft parts 232 identified by configuration selections 236 on aircraft 228.

Installation module 220 may be configured to assist software installer 212 or other users 206 to install selected software aircraft parts 232 identified by configuration selections 236 on aircraft 228. For example, installation module 220 may be configured to generate installation instructions 240. Installation instructions 240 may identify selected software aircraft parts 232 identified by configuration selections 236 for installation on aircraft 228. Installation instructions 240 may also include other information that may be used by software installer 212 or other users 206 for installing software aircraft parts 232 identified by configuration selections 236 on aircraft 228.

For example, without limitation, software installer 212 may access configuration tool 200 via network 208 using installation device 242. Installation device 242 may be portable installation device 244. For example, without limitation, portable installation device 244 may be a laptop computer, other portable computer, or other type of portable data processing device. In this example, installation module 220 may be configured to display installation instructions 240 on portable installation device 244.

Software installer 212 may load software aircraft parts 232 identified by installation instructions 240 from database 234 onto portable installation device 244. Alternatively, some or all of software aircraft parts 232 identified by installation instructions 240 may be already loaded on portable installation device 244. Software installer 212 then may install software aircraft parts 232 identified in installation instructions 240 on aircraft 228 from portable installation device 244.

Installation module 220 may be configured to receive installation confirmation 246 from software installer 212 or other users 206. Installation confirmation 246 may include information indicating that software aircraft parts 232 identified in configuration selections 236 have been installed on aircraft 228. For example, without limitation, installation confirmation 246 may identify when software aircraft parts 232 were installed on aircraft 228.

Report generator 222 may be configured to generate various reports that may be used by users 206 to manage the configuration of aircraft 228. For example, without limitation, report generator 222 may be configured to generate installation report 248 and configuration report 250. Installation report 248 may include information identifying software aircraft parts 232 identified in configuration selections 236 that have been installed on aircraft 228. Configuration report 250 may include information identifying the configuration of aircraft 228 including software aircraft parts 232 installed on aircraft 228. Installation report 248 and configuration report 250 may be provided by report generator 222 in any appropriate form. Users 206 may access installation report 248, configuration report 250, or both from configuration tool 200 via network 208.

Notification generator 224 may be configured to generate and deliver various notifications to users 206 automatically in response to various other actions occurring in configuration tool 200. Notification generator 224 may generate and deliver notifications to users 206 in the form of e-mail messages, text messages, or in any other appropriate form or combination of forms. For example, without limitation, notification generator 224 may be configured to generate and deliver a notification to software installer 212 or other users 206 in response to receiving installation authorization 238 from aircraft operator 210 or other users 206.

The illustration of FIG. 2 is not meant to imply physical or architectural limitations to the manner in which different illustrative embodiments may be implemented. Other components in addition to, in place of, or both in addition to and in place of the ones illustrated may be used. Some components may be unnecessary in some illustrative embodiments. Also, the blocks are presented to illustrate some functional components. One or more of these blocks may be combined or divided into different blocks when implemented in different illustrative embodiments.

For example, configuration tool 200 may be used for the selection of configurable aircraft parts for installation on aircraft 228 other than configurable software aircraft parts 232. Configuration tool 200 may be used for the selection and installation of configurable software or other parts on platform 252 other than aircraft 228. Aircraft 228 may be one example of platform 252. Configuration tool 200 may be used to select and install configurable software or other parts for platform 252 other than aircraft 228. For example, platform 252 may be another type of vehicle or other mobile structure. Platform 252 may be an aerospace vehicle that is capable of traveling through the air, in space, or both. As another example, without limitation, platform 252 may be a vehicle that is capable of travelling on land, on the surface of water, or under water. An illustrative embodiment also may be used for platform 252 that is not mobile.

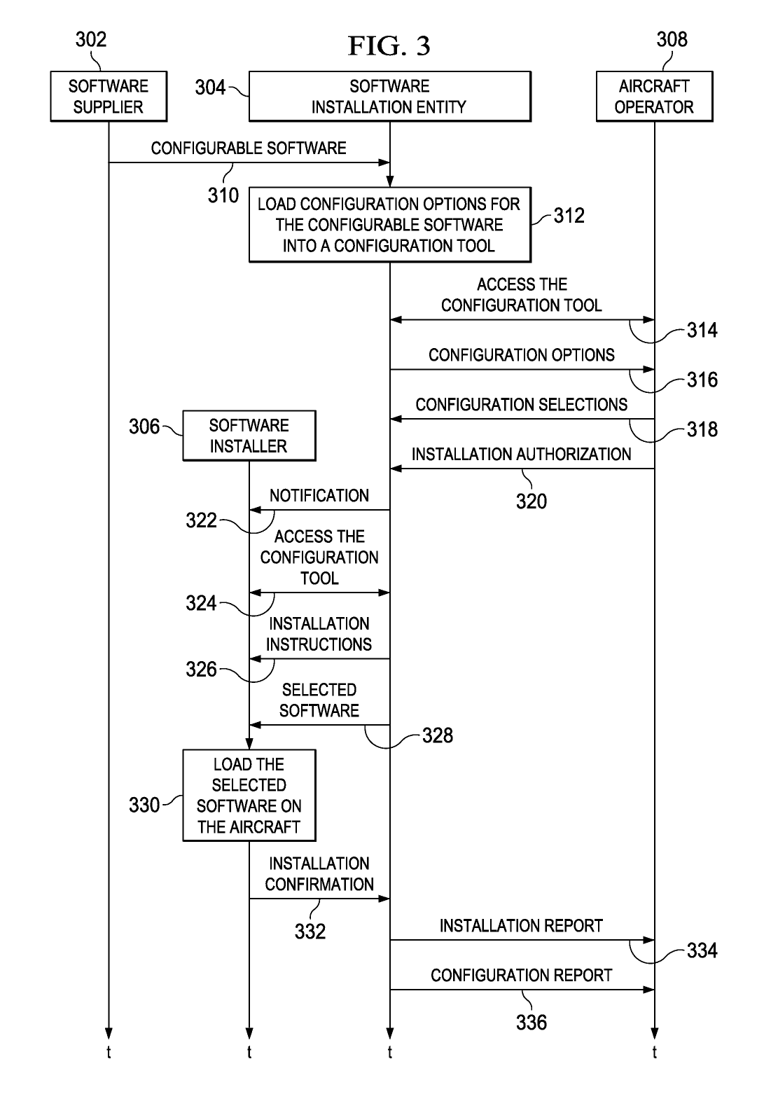

Turning now to FIG. 3, an illustration of information transfer for using a configuration tool is depicted in accordance with an illustrative embodiment. An example of information flow between software supplier 302, software installation entity 304, software installer 306, and aircraft operator 308 for using a configuration tool is depicted in accordance with an illustrative embodiment. In this example, software supplier 302 is an example of software suppliers 102 in FIG. 1. Software installation entity 304 is an example of software installation entity 120 in FIG. 1 and software installation entity 202 in FIG. 2. Software installer 306 is an example of software installer 127 in FIG. 1 and software installer 212 in FIG. 2. Aircraft operator 308 is an example of aircraft operator 108 in FIG. 1 and aircraft operator 210 in FIG. 2.

Software supplier 302 may provide configurable software 310 to software installation entity 304. Software installation entity 304 may load configuration options for the configurable software into a configuration tool 312. Software installation entity 304 may operate the configuration tool in accordance with an illustrative embodiment.

Aircraft operator 308 may access the configuration tool 314 operated by software installation entity 304. Configuration options 316 for configurable software 310 may be provided to aircraft operator 308 using the configuration tool. For example, configuration options 316 for configurable software 310 may be displayed to aircraft operator 308 by the configuration tool. Aircraft operator 308 may use the configuration tool to make configuration selections 318 from configuration options 316 presented to aircraft operator 308. Configuration selections 318 thus may be provided from aircraft operator 308 to software installation entity 304 using the configuration tool. After making configuration selections 318, aircraft operator 308 may send installation authorization 320 to software installation entity 304. Installation authorization 320 may be sent to software installation entity 304 using the configuration tool. Installation authorization 320 may authorize software installation entity 304 to install configurable software 310 that is configured in accordance with configuration selections 318 on an aircraft operated by aircraft operator 308.

Software installation entity 304 may send notification 322 to software installer 306. Notification 322 may indicate to software installer 306 that there is configurable software 310 that has been authorized by aircraft operator 308 to be installed on an aircraft. Notification 322 may be sent to software installer 306 using the configuration tool operated by software installation entity 304. For example, notification 322 may be sent to software installer 306 by the configuration tool automatically in response to receiving installation authorization 320 from aircraft operator 308.

In response to receiving notification 322, software installer 306 may access the configuration tool 324 operated by software installation entity 304. Software installer 306 may obtain installation instructions 326 from software installation entity 304 using the configuration tool. Installation instructions 326 may identify selected software 328 to be installed on an aircraft. Selected software 328 may include configurable software 310. In this case, installation instructions 326 may identify configuration selections 318 for configurable software 310 as made and authorized by aircraft operator 308.

Software installer 306 may obtain selected software 328, as identified by installation instructions 326, from software installation entity 304. Selected software 328 may be obtained from software installation entity 304 using the configuration tool operated by software installation entity 304. Software installer 306 then may load the selected software on the aircraft 330 following installation instructions 326.

Software installer 306 may send installation confirmation 332 to software installation entity 304. Installation confirmation 332 may be sent to software installation entity 304 using the configuration tool operated by software installation entity 304. Installation confirmation 332 may include information indicating that selected software 328 has been installed on an aircraft in accordance with installation instructions 326.

Software installation entity 304 may provide installation report 334, configuration report 336, or both to aircraft operator 308. Installation report 334 may include information indicating that configurable software 310 that has been configured in accordance with configuration selections 318 has been installed on an aircraft as authorized by aircraft operator 308. Configuration report 336 may include information identifying the configuration of the aircraft with configurable software 310 that has been configured in accordance with configuration selections 318 installed thereon.

Installation report 334, configuration report 336, or both may be sent to aircraft operator 308 using the configuration tool operated by software installation entity 304. For example, without limitation, installation report 334, configuration report 336, or both may be generated by the configuration tool and sent to aircraft operator 308 in response to the configuration tool receiving installation confirmation 332. Alternatively, or in addition, aircraft operator 308 may retrieve installation report 334, configuration report 336, or both from software installation entity 304 using the configuration tool.

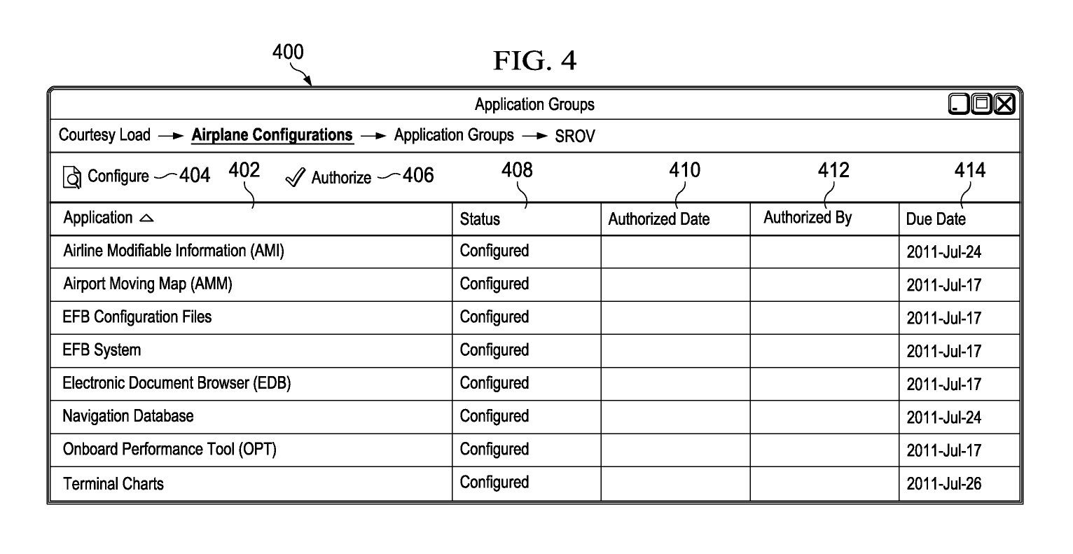

Turning now to FIG. 4, an illustration of a user interface for selecting an application group of software aircraft parts to be configured is depicted in accordance with an illustrative embodiment. In this example, user interface 400 is an example of one implementation of user interfaces 226 for configuration tool 200 in FIG. 2.

In this example, user interface 400 may display a list 402 of software application groups for software that may be installed on an aircraft. Each of the application groups in list 402 may include software aircraft parts that may be configured by a user. The user may select one of the application groups in list 402 and then select virtual button 404 to configure software within the selected application group. The user may select one of the application groups in list 402 and then select virtual button 406 to authorize installation on the aircraft of the configured software within the selected application group.

User interface 400 may also indicate status 408, authorized date 410, authorized by 412, and due date 414 for each of the application groups in list 402. Status 408 may indicate whether or not software in an application group has been configured or is yet to be configured by a user. Authorized date 410 may indicate when the user authorized installation on the aircraft of configured software in an application group. Authorized by 412 may indicate the identity of an individual person who authorized the installation on the aircraft of the configured software in an application group. Due date 414 may indicate a date by which configuration and authorization to install the software in an application group may be desired.

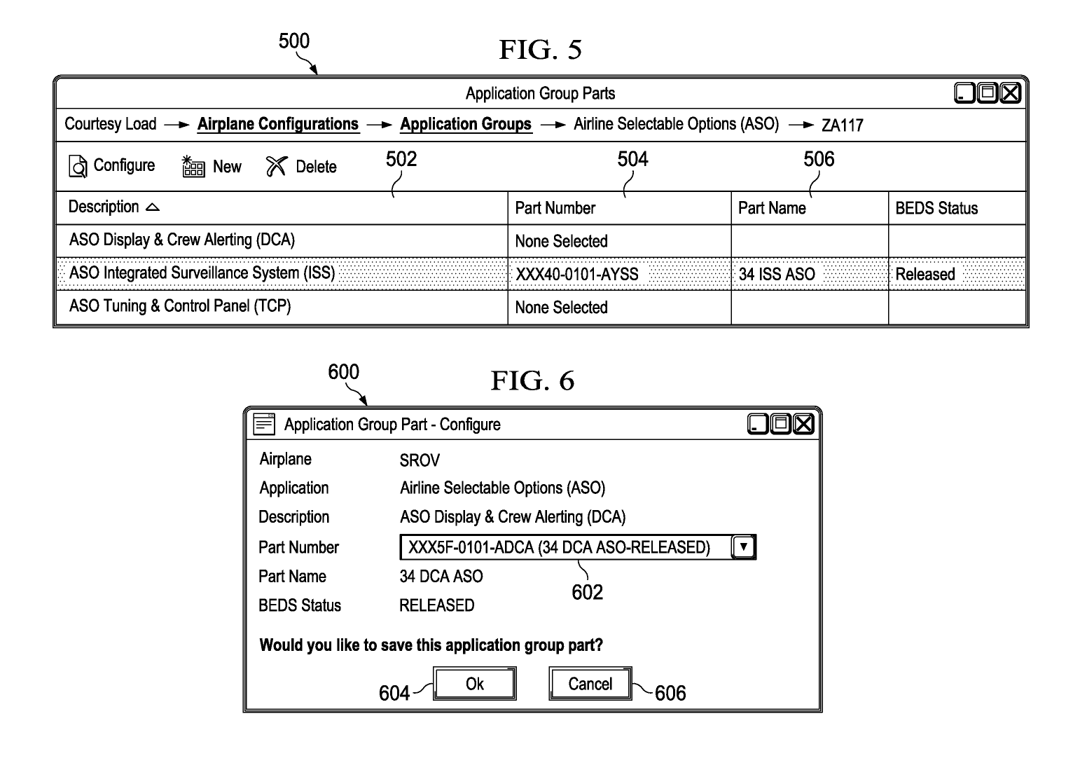

Turning now to FIG. 5, an illustration of a user interface for selecting a software aircraft part to be configured is depicted in accordance with an illustrative embodiment. In this example, user interface 500 is an example of one implementation of user interfaces 226 for configuration tool 200 in FIG. 2.

User interface 500 may be displayed to a user in response to the user selecting a software application group including software aircraft parts to be configured. For example, user interface 500 may be displayed in response to a user selecting an application group in list 402 and virtual button 404 in user interface 400 in FIG. 4. User interface 500 may display a list of the software parts in the selected application group that may be configured by the user. For example, without limitation, software parts in the application group that may be configured by a user may be identified in user interface 500 by description 502, part number 504, and part name 506. The user may select one of the software parts identified in user interface 500 to configure that software part.

Turning now to FIG. 6, an illustration of a user interface for selecting a configuration for a software aircraft part is depicted in accordance with an illustrative embodiment. In this example, user interface 600 is an example of one implementation of user interfaces 226 for configuration tool 200 in FIG. 2.

User interface 600 may be displayed to a user in response to the user selecting a software aircraft part to be configured. For example, user interface 600 may be displayed in response to the user selecting a software part to configure in user interface 500 in FIG. 5. In this example, the user may configure the software aircraft part by selecting a configuration for the software part from menu 602 of available configuration options for the software part in user interface 600. In this example, each configuration option for the software part may be identified by a separate software aircraft part number and menu 602 of available configuration options may comprise a list of software aircraft part numbers for the aircraft software to configure. The user may accept a selected configuration option for the software part by selecting virtual button 604 in user interface 600. The user may cancel a selected configuration option for the software part by selecting virtual button 606 in user interface 600.

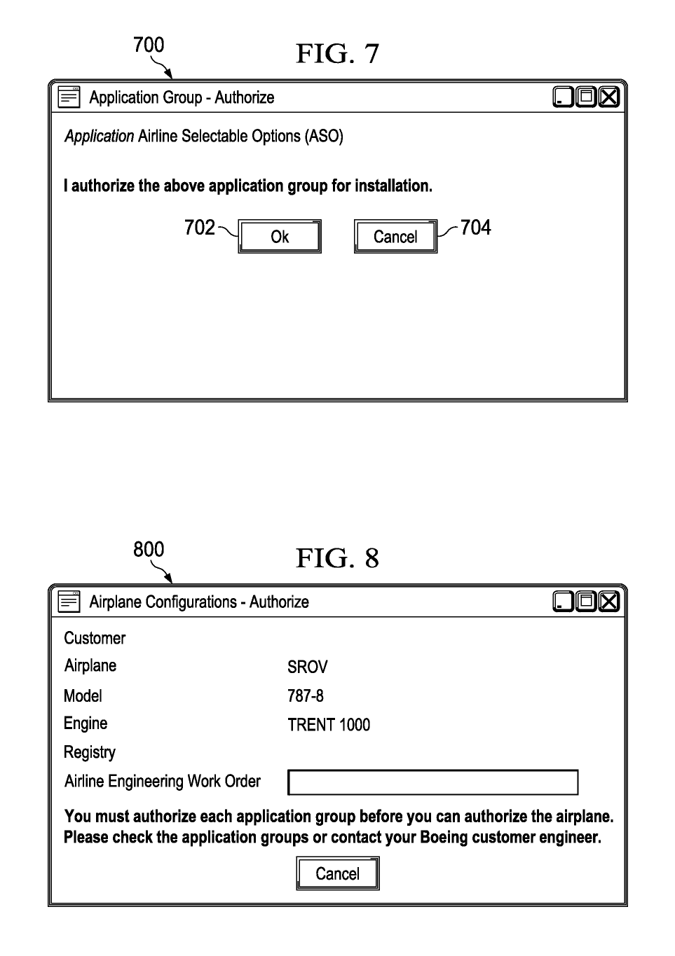

Turning now to FIG. 7, an illustration of a user interface for authorizing installation of an application group of configured software aircraft parts is depicted in accordance with an illustrative embodiment. In this example, user interface 700 is an example of one implementation of user interfaces 226 for configuration tool 200 in FIG. 2.

User interface 700 may be displayed to the user in response to the user selecting an application group of software aircraft parts that have been configured by the user and are ready to be installed on an aircraft. For example, user interface 700 may be displayed in response to a user selecting an application group in list 402 and virtual button 406 in user interface 400 in FIG. 4. The user may select virtual button 702 in user interface 700 to authorize the installation of the configured software parts in the application group on the aircraft. The user may select virtual button 704 in user interface 700 to cancel the authorization to install the configured software parts in the application group.

Turning now to FIG. 8, an illustration of a user interface for authorizing an aircraft configuration is depicted in accordance with an illustrative embodiment. In this example, user interface 800 is an example of one implementation of user interfaces 226 for configuration tool 200 in FIG. 2.

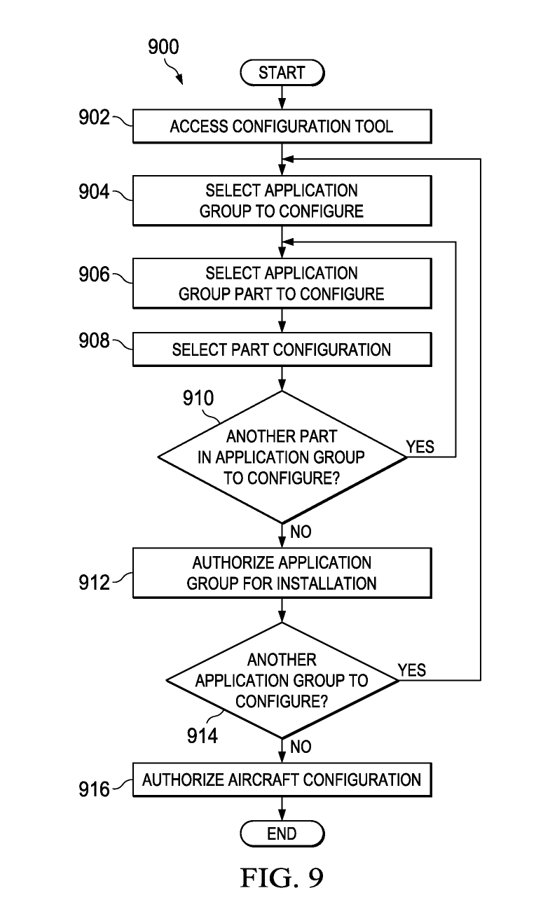

Turing now to FIG. 9, an illustration of a flowchart of a process for using a configuration tool to configure software aircraft parts is depicted in accordance with an illustrative embodiment. For example, the process 900 may be performed by aircraft operator 210 or another user using configuration tool 200 in FIG. 2.

The process begins by accessing the configuration tool (operation 902). For example, a user may access the configuration tool via the Internet or another appropriate network or other connection.

The configuration tool then may be used to select an application group to configure (operation 904). For example, the configuration tool may be configured to display a list of software application groups for software that may be installed on an aircraft. Each of the application groups in the displayed list may include software aircraft parts that may be configured by the user. Operation 904 may include selecting an application group from the list of application groups that is displayed by the configuration tool.

The configuration tool may then be used to select an application group part to configure (operation 906). For example, in response to selecting an application group in operation 904, the configuration tool may display a list of the software parts in the selected application group that may be configured by the user. Operation 906 may include selecting a software part to configure from the list of software parts displayed by the configuration tool.

The application tool then may be used to select a part configuration (operation 908). For example, in response to selecting a software part to configure in operation 906, the configuration tool may display configuration options for the selected software part. Operation 908 may include selecting one of the configuration options for the software part. For example, without limitation, the configuration options may comprise a list of software aircraft part numbers for the aircraft software to configure that is displayed by the configuration tool. In this case, operation 908 may include selecting a software aircraft part number from the list of software aircraft part numbers for the aircraft software to configure that is displayed by the configuration tool.

It then may be determined whether there is another part in the application group to be configured (operation 910). If it is determined at operation 910 that there is another part in the application group to be configured, the process may return to operation 906 and the configuration tool may be used to select another part in the application group to be configured. If is determined at operation 910 that there is not another part in the application group to be configured the configuration tool may be used to authorize installation of the application group (operation 912).

It then may be determined whether there is another application group to be configured (operation 914). If it is determined that there is another application group to be configured, the process may return to operation 904 and the configuration tool may be used to select another application group to be configured. If it is determined that there is not another application group to be configured, the aircraft configuration may be authorized (operation 916), with the process terminating thereafter.

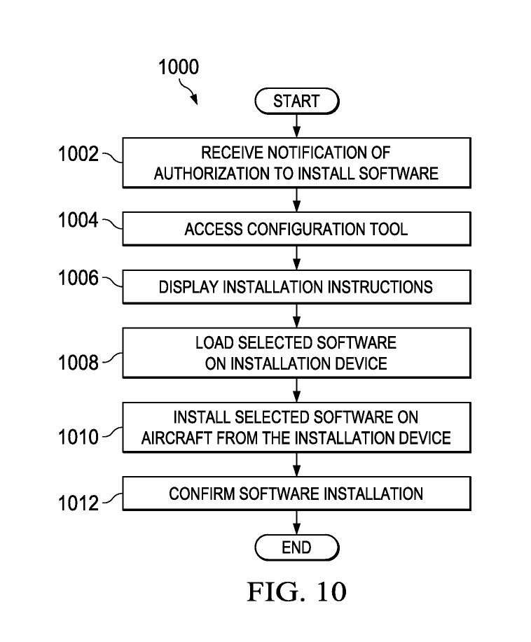

Turning now to FIG. 10, an illustration of a flowchart of a process for using a configuration tool to install software aircraft parts on an aircraft is depicted in accordance with an illustrative embodiment. For example, the process 1000 may be performed by software installer 212 or another user using configuration tool 200 in FIG. 2.

The process may begin with the software installer receiving notification of an authorization to install software (operation 1002). For example, the configuration tool may be configured to generate and send an electronic mail or other message to the software installer in response to an authorization from an aircraft operator or other entity to install software on the aircraft. The software to be installed on the aircraft may include software aircraft parts that have been configured by the aircraft operator or other entity using the configuration tool.

The software installer may respond to the notification by accessing the configuration tool (operation 1004). For example, the software installer may access the configuration tool via the Internet or another appropriate network or other connection using a portable installation device. The configuration tool may display installation instructions (operation 1006). For example, the installation instructions may be displayed by the configuration tool on the portable installation device. The installation instructions may identify selected software to be installed on the aircraft. The software installer may use the displayed installation instructions to load the selected software identified by the installation instructions on the installation device (operation 1008). The software installer then may install the selected software on the aircraft from the installation device (operation 1010). The software installer then may use the configuration tool to confirm installation of the selected software on the aircraft (operation 1012), with the process terminating thereafter.

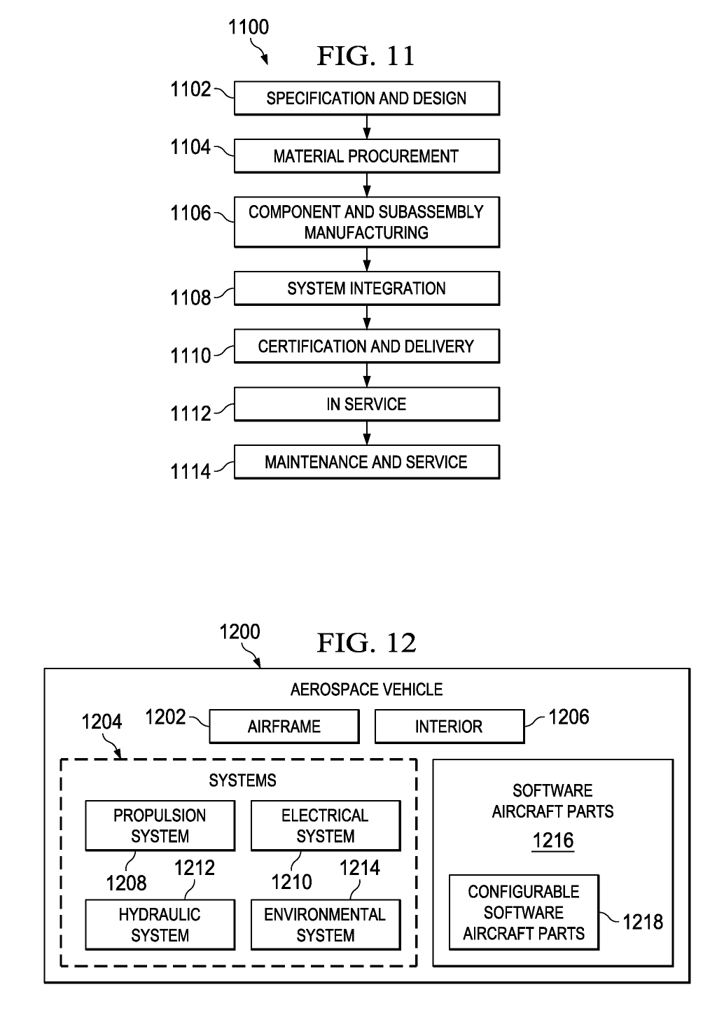

Illustrative embodiments of the disclosure may be described in the context of aerospace vehicle manufacturing and service method 1100 as shown in FIG. 11 and aerospace vehicle 1200 as shown in FIG. 12. Turning first to FIG. 11, an illustration of a block diagram of an aerospace vehicle manufacturing and service method is depicted in accordance with an illustrative embodiment.

During pre-production, aerospace vehicle manufacturing and service method 1100 may include specification and design 1102 of aerospace vehicle 1200 in FIG. 12 and material procurement 1104. During production, component and subassembly manufacturing 1106 and system integration 1108 of aerospace vehicle 1200 in FIG. 12 takes place. Thereafter, aerospace vehicle 1200 in FIG. 12 may go through certification and delivery 1110 in order to be placed in service 1112.

While in service by a customer, aerospace vehicle 1200 in FIG. 12 is scheduled for routine maintenance and service 1114, which may include modification, reconfiguration, refurbishment, and other maintenance or service. In this example, aerospace vehicle manufacturing and service method 1100 is shown as a method for aerospace vehicles, including manned and unmanned aircraft. The different illustrative embodiments may be applied to other types of manufacturing and service methods, including manufacturing and service methods for other types of platforms, including other types of vehicles.

Each of the processes of aerospace vehicle manufacturing and service method 1100 may be performed or carried out by a system integrator, a third party, an operator, or by any combination of such entities. In these examples, the operator may be a customer. For the purposes of this description, a system integrator may include, without limitation, any number of aerospace vehicle manufacturers and major-system subcontractors; a third party may include, without limitation, any number of venders, subcontractors, and suppliers; and an operator may be a company, a military entity, a service organization, and so on.

With reference now to FIG. 12, an illustration of a block diagram of an aerospace vehicle in which an illustrative embodiment may be implemented is depicted. In this illustrative example, aerospace vehicle 1200 is produced by aerospace vehicle manufacturing and service method 1100 in FIG. 1. Aerospace vehicle 1200 may include an aircraft, a spacecraft, or any other vehicle for traveling through the air, for traveling through space, or which is capable of operation in both air and space. Aerospace vehicle 1200 may include airframe 1202 with systems 1204 and interior 1206.

Examples of systems 1204 include one or more of propulsion system 1208, electrical system 1210, hydraulic system 1212, and environmental system 1214. Aerospace vehicle 1200 also may include software aircraft parts 1216. Software aircraft parts 1216 may include configurable software aircraft parts 1218. Illustrative embodiments may be used to select and install configurable software aircraft parts 1218 on aerospace vehicle 1200.

Apparatuses and methods embodied herein may be employed during at least one of the stages of aerospace vehicle manufacturing and service method 1100 in FIG. 11. As used herein, the phrase “at least one of,” when used with a list of items, means that different combinations of one or more of the listed items may be used and only one of each item in the list may be needed. For example, “at least one of item A, item B, and item C” may include, for example, without limitation, item A, or item A and item B. This example also may include item A, item B, and item C, or item B and item C.

In one illustrative example, components or subassemblies produced in component and subassembly manufacturing 1106 in FIG. 11 may be fabricated or manufactured in a manner similar to components or subassemblies produced while aerospace vehicle 1200 is in service 1112 in FIG. 11.

As yet another example, a number of apparatus embodiments, method embodiments, or a combination thereof may be utilized during production stages, such as component and subassembly manufacturing 1106 and system integration 1108 in FIG. 11. “A number,” when referring to items, means one or more items. For example, “a number of apparatus embodiments” is one or more apparatus embodiments. A number of apparatus embodiments, method embodiments, or a combination thereof may be utilized while aerospace vehicle 1200 is in service 1112, during maintenance and service 1114, or both.

The use of a number of the different illustrative embodiments may substantially expedite the assembly of aerospace vehicle 1200. A number of the different illustrative embodiments may reduce the cost of aerospace vehicle 1200. For example, one or more of the different illustrative embodiments may be used during component and subassembly manufacturing 1106, during system integration 1108, or both. The different illustrative embodiments may be used during these parts of aerospace vehicle manufacturing and service method 1100 to select and install configurable software aircraft parts 1218 on aerospace vehicle 1200. Further, the different illustrative embodiments also may be implemented during in service 1112, during maintenance and service 1114 or both, to select and install configurable software aircraft parts 1218 on aerospace vehicle 1200.

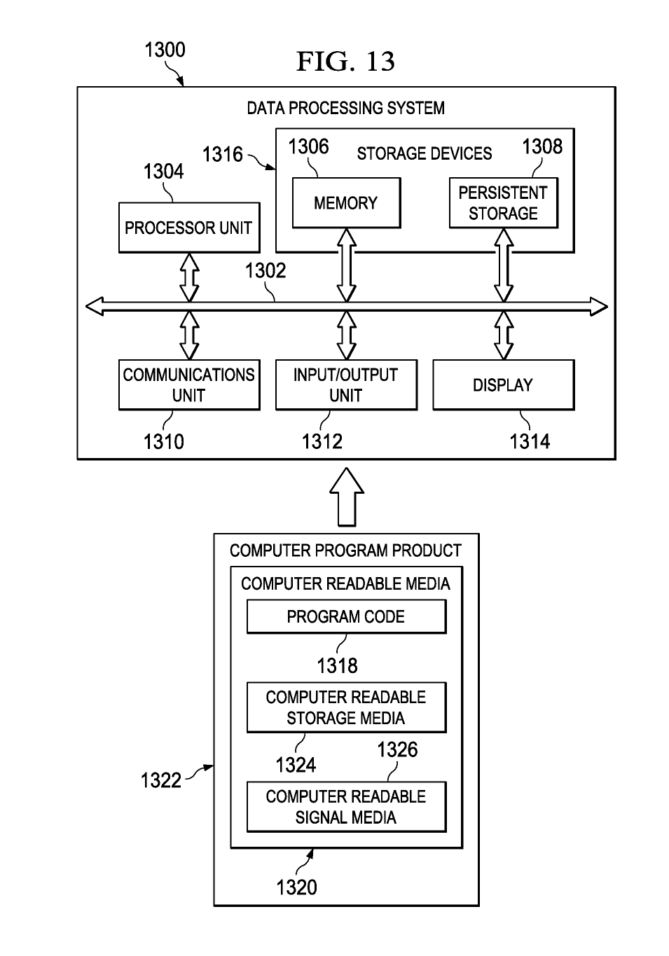

Turning now to FIG. 13, an illustration of a data processing system is depicted in accordance with an illustrative embodiment. In this example, data processing system 1300 is an example of one implementation of a data processing system in which configuration tool 200 in FIG. 2 may be implemented. Data processing system 1300 also is an example of one implementation of a data processing system in which installation device 242 in FIG. 2.

In this illustrative example, data processing system 1300 includes communications fabric 1302. Communications fabric 1302 provides communications between processor unit 1304, memory 1306, persistent storage 1308, communications unit 1310, input/output unit 1312, and display 1314. Memory 1306, persistent storage 1308, communications unit 1310, input/output unit 1312, and display 1314 are examples of resources accessible by processor unit 1304 via communications fabric 1302.

Processor unit 1304 serves to run instructions for software that may be loaded into memory 1306. Processor unit 1304 may be a number of processors, a multi-processor core, or some other type of processor, depending on the particular implementation. Further, processor unit 1304 may be implemented using a number of heterogeneous processor systems in which a main processor is present with secondary processors on a single chip. As another illustrative example, processor unit 1304 may be a symmetric multi-processor system containing multiple processors of the same type.

Memory 1306 and persistent storage 1308 are examples of storage devices 1316. A storage device is any piece of hardware that is capable of storing information such as, for example, without limitation, data, program code in functional form, and/or other suitable information either on a temporary basis and/or a permanent basis. Storage devices 1316 may also be referred to as computer readable storage devices in these examples. Memory 1306, in these examples, may be, for example, a random access memory or any other suitable volatile or non-volatile storage device. Persistent storage 1308 may take various forms, depending on the particular implementation.

For example, persistent storage 1308 may contain one or more components or devices. For example, persistent storage 1308 may be a hard drive, a flash memory, a rewritable optical disk, a rewritable magnetic tape, or some combination of the above. The media used by persistent storage 1308 also may be removable. For example, a removable hard drive may be used for persistent storage 1308.

Communications unit 1310, in these examples, provides for communications with other data processing systems or devices. In these examples, communications unit 1310 is a network interface card. Communications unit 1310 may provide communications through the use of either or both physical and wireless communications links.

Input/output unit 1312 allows for input and output of data with other devices that may be connected to data processing system 1300. For example, input/output unit 1312 may provide a connection for user input through a keyboard, a mouse, and/or some other suitable input device. Further, input/output unit 1312 may send output to a printer. Display 1314 provides a mechanism to display information to a user.

Instructions for the operating system, applications, and/or programs may be located in storage devices 1316, which are in communication with processor unit 1304 through communications fabric 1302. In these illustrative examples, the instructions are in a functional form on persistent storage 1308. These instructions may be loaded into memory 1306 for execution by processor unit 1304. The processes of the different embodiments may be performed by processor unit 1304 using computer-implemented instructions, which may be located in a memory, such as memory 1306.

These instructions are referred to as program instructions, program code, computer usable program code, or computer readable program code that may be read and executed by a processor in processor unit 1304. The program code in the different embodiments may be embodied on different physical or computer readable storage media, such as memory 1306 or persistent storage 1308.

Program code 1318 is located in a functional form on computer readable media 1320 that is selectively removable and may be loaded onto or transferred to data processing system 1300 for execution by processor unit 1304. Program code 1318 and computer readable media 1320 form computer program product 1322 in these examples. In one example, computer readable media 1320 may be computer readable storage media 1324 or computer readable signal media 1326.

Computer readable storage media 1324 may include, for example, an optical or magnetic disk that is inserted or placed into a drive or other device that is part of persistent storage 1308 for transfer onto a storage device, such as a hard drive, that is part of persistent storage 1308. Computer readable storage media 1324 also may take the form of a persistent storage, such as a hard drive, a thumb drive, or a flash memory, that is connected to data processing system 1300. In some instances, computer readable storage media 1324 may not be removable from data processing system 1300.

In these examples, computer readable storage media 1324 is a physical or tangible storage device used to store program code 1318 rather than a medium that propagates or transmits program code 1318. Computer readable storage media 1324 is also referred to as a computer readable tangible storage device or a computer readable physical storage device. In other words, computer readable storage media 1324 is a media that can be touched by a person.

Alternatively, program code 1318 may be transferred to data processing system 1300 using computer readable signal media 1326. Computer readable signal media 1326 may be, for example, a propagated data signal containing program code 1318. For example, computer readable signal media 1326 may be an electromagnetic signal, an optical signal, or any other suitable type of signal. These signals may be transmitted over communications links, such as wireless communications links, optical fiber cable, coaxial cable, a wire, or any other suitable type of communications link. In other words, the communications link or the connection may be physical or wireless in the illustrative examples.

In some illustrative embodiments, program code 1318 may be downloaded over a network to persistent storage 1308 from another device or data processing system through computer readable signal media 1326 for use within data processing system 1300. For instance, program code stored in a computer readable storage medium in a server data processing system may be downloaded over a network from the server to data processing system 1300. The data processing system providing program code 1318 may be a server computer, a client computer, or some other device capable of storing and transmitting program code 1318.

The different components illustrated for data processing system 1300 are not meant to provide architectural limitations to the manner in which different embodiments may be implemented. The different illustrative embodiments may be implemented in a data processing system including components in addition to and/or in place of those illustrated for data processing system 1300. Other components shown in FIG. 13 can be varied from the illustrative examples shown. The different embodiments may be implemented using any hardware device or system capable of running program code. As one example, data processing system 1300 may include organic components integrated with inorganic components and/or may be comprised entirely of organic components excluding a human being. For example, a storage device may be comprised of an organic semiconductor.

In another illustrative example, processor unit 1304 may take the form of a hardware unit that has circuits that are manufactured or configured for a particular use. This type of hardware may perform operations without needing program code to be loaded into a memory from a storage device to be configured to perform the operations.

For example, when processor unit 1304 takes the form of a hardware unit, processor unit 1304 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, a programmable array logic, a field programmable logic array, a field programmable gate array, and other suitable hardware devices. With this type of implementation, program code 1318 may be omitted, because the processes for the different embodiments are implemented in a hardware unit.

In still another illustrative example, processor unit 1304 may be implemented using a combination of processors found in computers and hardware units. Processor unit 1304 may have a number of hardware units and a number of processors that are configured to run program code 1318. With this depicted example, some of the processes may be implemented in the number of hardware units, while other processes may be implemented in the number of processors.

In another example, a bus system may be used to implement communications fabric 1302 and may be comprised of one or more buses, such as a system bus or an input/output bus. Of course, the bus system may be implemented using any suitable type of architecture that provides for a transfer of data between different components or devices attached to the bus system.

Additionally, communications unit 1310 may include a number of devices that transmit data, receive data, or transmit and receive data. Communications unit 1310 may be, for example, a modem or a network adapter, two network adapters, or some combination thereof. Further, a memory may be, for example, memory 1306, or a cache, such as found in an interface and memory controller hub that may be present in communications fabric 1302.

The flowcharts and block diagrams in the different depicted embodiments illustrate the structure, functionality, and operation of some possible implementations of apparatuses and methods in different illustrative embodiments. In this regard, each block in the flowcharts or block diagrams may represent a module, segment, function, or a portion of an operation or step. In some alternative implementations, the function or functions noted in the blocks may occur out of the order noted in the figures. For example, in some cases, two blocks shown in succession may be executed substantially concurrently, or the blocks may sometimes be executed in the reverse order, depending upon the functionality involved.

The description of the different illustrative embodiments has been presented for purposes of illustration and description, and is not intended to be exhaustive or to limit the embodiments in the form disclosed. Many modifications and variations will be apparent to those of ordinary skill in the art. Further, different illustrative embodiments may provide different advantages as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. An apparatuses configured to execute instructions via a processor unit that comprises:
a configuration tool connected to: a platform manufacturer, a platform operator, and a part supplier, such that the configuration tool comprises an access controller, a user interface generator, a configuration selector, an installation module, a report generator, and a notification generator, and configured such that in operation, the configuration tool:
displays configuration options for a part for the platform on a user interface;
receives a configuration selection for the part, wherein the configuration selection identifies one of the configuration options; and
sends the configuration selection to an installer for installation, of the part identified by the configuration selection, on the platform.

2. The apparatus of claim 1, further comprising:
the configuration tool configured such that in operation, the configuration options display via an Internet and receive the configuration selection via the Internet; and
the part is software.

3. The apparatus of claim 1, wherein the configuration tool is further configured, such that in operation the installation module receives an installation authorization to install the part, identified by the configuration selection, on the platform.

4. The apparatus of claim 3, wherein the configuration tool is further configured such that in operation the notification generator sends a notification to the installer automatically in response to receipt of the installation authorization in the installation module.

5. The apparatus of claim 1, wherein the configuration tool is further configured such that in operation the configuration tool displays, installation instructions to the installer, wherein the installation instructions identify the part identified by the configuration selection.

6. The apparatus of claim 1, wherein the configuration tool is further configured such that in operation the configuration tool receives, from the installer, an installation confirmation that indicates the part identified by the configuration selection as being installed on the platform.

7. The apparatus of claim 6, wherein the configuration tool is further configured such that in operation the report generator generates, a configuration report identifying a configuration of the platform that comprises the configuration selection installed on the platform.

8. The apparatus of claim 1, further comprising the platform being in production, component and subassembly manufacturing.

9. The apparatus of claim 1, wherein the part comprises a software aircraft part.

10. A method for selecting a configuration for a platform, comprising:
receiving, in a configuration tool connected to: a network, a platform manufacturer, a platform operator, and a part supplier, such that the configuration tool comprises an access controller, a user interface generator, a configuration selector, and an installation module, via the network, configuration options;
the access controller receiving, via the network, a request for access and an identification of the platform;
transmitting, via the configuration selector, to a user interface, configuration options that comprise identities of parts received from a group that comprises the platform manufacturer, the platform operator, and the part supplier;
receiving, in the configuration selector, a configuration selection from among the configuration options;
receiving, in the configuration selector, via the network, an installation authorization for a part in the configuration selection;
transmitting, from the installation module to an installer via the network, an installation instruction that comprises an identity of the part; and
receiving, in the installation module, an installation confirmation of part installation in the platform in accordance with the installation instruction.

11. The method of claim 10, wherein the network comprises an Internet.

12. The method of claim 10, further comprising the configuration selection comprising:
an application group of software aircraft parts to configure from a list of application groups of software aircraft parts displayed by the configuration tool; and
a software aircraft part to configure from a list of software aircraft parts in the application group of software aircraft parts displayed by the configuration tool.

13. The method of claim 10, further comprising the configuration selection comprising:
a software aircraft part number from a list of software aircraft part numbers for the aircraft software to configure.

14. The method of claim 10 further comprising:
the instruction being for installation, on an aircraft, of aircraft software.

15. A method for installing software on an aircraft, the method comprising:
connecting a configuration tool, comprising a processor unit, to a network, an aircraft manufacturer, an aircraft operator, and a software supplier, the configuration tool comprising: an access controller, a user interface generator, a configuration selector, and an installation module;
receiving, in the configuration tool via the network, a configurable software and configurable options for the configurable software;
the access controller receiving, via the network, a request for access and an identification of the aircraft;
transmitting, via the configuration selector, to a user interface, configuration options that comprise identities of parts received from a group that comprises the aircraft manufacturer, the aircraft operator, and the software supplier;
receiving, in the configuration selector, a configuration selection from among the configuration options;
displaying, by the installation module via the network, installation instructions from the configuration tool for installing aircraft software on the aircraft, wherein the installation instructions identify selected aircraft software selected from configuration options for the aircraft software displayed by the configuration tool;
receiving, in the installation module, an installation confirmation of part installation in the aircraft in accordance with the installation instruction;
transmitting, via the network from a report generator in the configuration tool, an installation report and a configuration report that comprises identifying configurable software on the aircraft configured in accordance with the configuration selection; and
delivering to the user interface, from a notification generator in the configuration tool, in response to an action occurring in the configuration tool, a notification.

16. The method of claim 15, further comprising
the notification indicating an authorization to install the selected aircraft software on the aircraft.

17. The method of claim 15, further comprising the network comprising an Internet.

18. The method of claim 15, a further comprising the configuration tool transmitting the notification, installation instructions, and selected aircraft software via the network to a software installer comprising a portable installation device.

19. The method of claim 18 further comprising:
loading the selected aircraft software in the portable installation device; and
installing the selected aircraft software on the aircraft from the portable installation device.

20. The method of claim 19 further comprising:
receiving via the network, the installation confirmation in the configuration tool, wherein the installation confirmation indicates that the selected aircraft software has been installed on the aircraft.
